(19) United States
(12) Patent Application Publication
(10) Pub. No.: US 2010/0199020 A1
(43) Pub. Date: Aug. 5, 2010

(54) NON-VOLATILE MEMORY SUBSYSTEM AND A MEMORY CONTROLLER THEREFOR

(75) Inventors: Fong-Long Lin, Fremont, CA (US); Prasanth Kumar, Fremont, CA (US); Dongsheng Xing, Fremont, CA (US)

Correspondence Address: DLA PIPER LLP (US ), 2000 UNIVERSITY AVENUE, EAST PALO ALTO, CA, 94303-2248, US

(73) Assignee: Silicon Storage Technology, Inc.

(21) Appl. No.: 12/365,829

(22) Filed: Feb. 4, 2009

(51) Int. Cl. G06F 12/02; G06F 12/00

(52) U.S. Cl. 711/103; 711/E12.001; 711/E12.008

(57) ABSTRACT

In the present invention a non-volatile memory subsystem comprises a non-volatile memory device and a memory controller. The memory controller controls the operation of the non-volatile memory device with the memory controller having a processor for executing computer program instructions for partitioning the non-volatile memory device into a plurality of partitions, with each partition having adjustable parameters for wear level and data retention. The memory subsystem also comprises a clock for supplying timing signals to the memory controller.

### TECHNICAL FIELD

The present invention relates to a non-volatile memory subsystem and more particularly to a non-volatile memory controller. The present invention also relates to a method of controlling the operation of a non-volatile memory device.

### BACKGROUND OF THE INVENTION

Nonvolatile memory devices having an array of non-volatile memory cells are well known in the art. Non-volatile memories can be of NOR type or NAND type. In certain types of non-volatile memories, the memory is characterized by having a plurality of blocks, with each block having a plurality of bits, with all of the bits in a block being erasable at the same time. Hence, these are called flash memories, because all of the bits or cells in the same block are erased together. After the block is erased, the cells within the block can be programmed by certain size (such as byte) as in the case of NOR memory, or a page is programmed at once as in the case of NAND memories.

One of the problems of flash non-volatile memory devices is that of data retention. The problem of data retention occurs because the insulator surrounding the floating gate will leak over time. Further, the erase/programming of a floating gate exacerbates the problem and therefore worsens the retention time as the floating gate is subject to more erase/programming cycles. Thus, it is desired to even out the “wear” or the number of cycles by which each block is erased. Hence, there is a desire to level the wear of blocks in a flash memory device.

Referring to FIG. 1 there is shown a schematic diagram of one method of the prior art in which wear leveling is accomplished. Associated with each block is a physical address, which is mapped to a user logical address. A memory device has a first plurality of blocks that are used to store data (designated as user logical blocks 0-977, with the associated physical blocks address designated as 200, 500, 501, 502, 508, 801 etc. through 100). The memory device also comprises a second plurality of blocks that comprise spare blocks, bad blocks and overhead blocks. The spare blocks may be erased blocks and other blocks that do not store data, or store data that has not been erased, or store status/information data that may be used by the controller 14. In the first embodiment of the prior art for leveling the wear on a block of non-volatile memory cells, when a certain block, such as user block 2, having a physical address of 501 (hereinafter all blocks shall be referred to by their physical address) is updated, new data or some old data in block 501 is moved to an erased block. A block from the Erased Pool, such as block 800, is chosen and the new data or some old data from block 501 is written into that block. In the example shown in FIG. 1, this is physical block 800, which is used to store new data. Physical block 800 is then associated with logical block 2 in the first plurality of blocks. Thereafter, block 501 is erased, and is then “moved” to be associated with the second plurality of erased blocks (hereinafter: “Erased Pool”). The “movement” of the physical block 501 from the first plurality of blocks (the stored data blocks) to the Erased Pool occurs by simply updating the table associating the user logical address block with the physical address block. Schematically, this is shown as the physical address block 501 is “moved” to the Erased Pool. When physical block 501 is returned to the Erased Pool, it is returned in a FIFO (First In First Out) manner. Thus, physical block 501 is the last block returned to the Erased Pool. Thereafter as additional erased blocks are returned to the Erased Pool, physical block pool is “pushed” to the top of the stack.

Referring to FIG. 2, there is shown a schematic diagram of another method of the prior art to level the wearing of blocks in a flash memory device. Specifically, associated with each of the physical blocks in the plurality of erased blocks is a counter counting the number of times that block has been erased. Thus, as the physical block 501 is erased, its associated erase counter is incremented. Within the second plurality of blocks, the blocks in the Erased Pool are arranged in a manner depending on the count in the erase counter associated with each physical block. The physical block having the youngest count, or the lowest count in the erase counter is poised to be the first to be returned to the first plurality of blocks to be used to store data. In particular, as shown in FIG. 2, for example, physical block 800 is shown as the “youngest” block, meaning that physical block 800 has the lowest count associated with the erased blocks in the Erased Pool. Physical block 501 from the first plurality is erased, its associated erase counter is incremented, and the physical block 501 is then placed among the second plurality of blocks (and if the erased block is able to retain data, it is returned to the Erased Pool). The erased block is placed in the Erased Pool depending upon the count in the erase counter associated with each of the blocks in the Erased Pool. As shown in FIG. 2, by way of example, the erase counter in physical block 501 after incrementing may have a count that places the physical block 501 between physical block 302 and physical block 303. Physical block 501 is then placed at that location.

The above described methods are called dynamic wear-leveling methods, in that wear level is considered only when data in a block is updated, i.e. the block would have had to be erased in any event. However, the dynamic wear-leveling method does not operate if there is no data update to a block. The problem with dynamic wear-leveling method is that for blocks that do not have data that is updated, such as those blocks storing operating system data or other types of data that is not updated or is updated infrequently, the wear level technique does not serve to cause the leveling of the wear for these blocks with all other blocks that have had more frequent changes in data. Thus, for example, if physical blocks 200 and 500 store operating system data, and are not updated at all or are updated infrequently, those physical blocks may have very little wear, in contrast to blocks such as physical block 501 (as well as all of the other blocks in the first plurality of blocks) that might have had greater wear. This large difference between physical blocks 501 and physical blocks 200 and 500, for example, may result in a lower over all usage of all the physical blocks of the NAND memory 20.

Another problem associated with flash non-volatile memory devices is endurance. Endurance refers to the number of read/write cycles a block can be subject to before the error in writing/reading to the block becomes too great for the error correction circuitry of the flash memory device to detect and correct.

Often, endurance is a reverse function of retention. Typically, as a block is subject to more write cycles, there is less retention time associated with that block. Furthermore, as the scale of integration increases, i.e. the geometry of the non-volatile memory device shrinks, the problems of both retention and endurance will worsen. Finally, retention and endurance are also specific to the type of data being stored. Thus, for data which is in the nature of programming code, retention is very important. In contrast data, which is in the nature of constantly changing data such as real time data, then endurance becomes important.

### SUMMARY OF THE INVENTION

In the present invention a non-volatile memory subsystem comprises a non-volatile memory device and a memory controller. The memory controller controls the operation of the non-volatile memory device with the memory controller having a processor for executing computer program instructions for partitioning the non-volatile memory device into a plurality of partitions, with each partition having adjustable parameters for wear level and data retention. The memory subsystem also comprises a clock for supplying timing signals to the memory controller.

The present invention also relates to a memory controller for controlling the operation of a non-volatile memory device. The memory controller comprises a processor and a memory for storing computer program instructions for execution by the processor. The program instructions are configured to partition the non-volatile memory device into a plurality of partitions, with each partition having adjustable parameters for wear level and data retention.

### BRIEF DESCRIPTION OF THE DRAWINGS

FIG. 1 is a schematic diagram of a first embodiment of a prior art method of performing wear level operation of a non-volatile memory subsystem.

FIG. 2 is a schematic diagram of a second embodiment of a prior art method of performing wear level operation of a non-volatile memory subsystem.

FIG. 3 is a schematic block diagram of a memory subsystem of the present invention

FIG. 4 is a detailed schematic block diagram of a memory controller of the present invention connected to a NAND non-volatile memory device.

FIG. 5 is a block level diagram of a NAND type memory device capable of being used in the memory subsystem of the present invention.

FIG. 6 is a schematic diagram of a method of performing wear level operation of a non-volatile memory device.

### DETAILED DESCRIPTION OF THE INVENTION

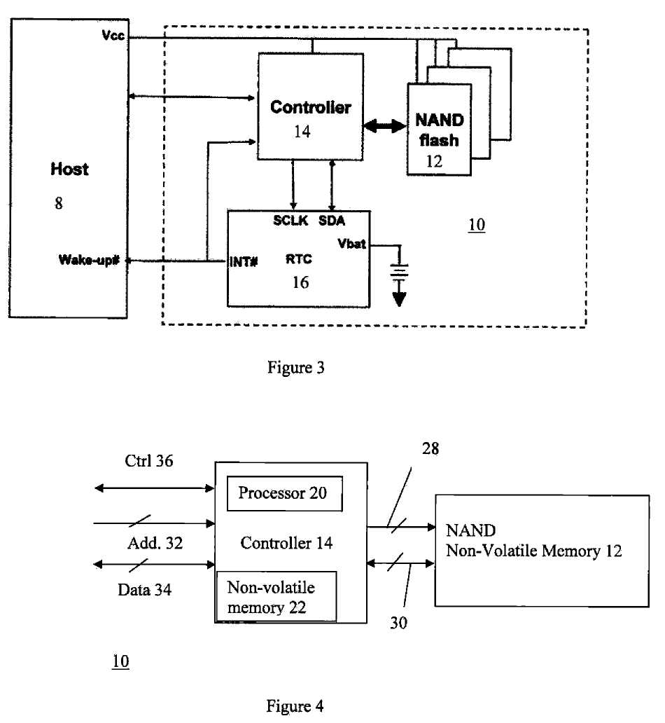

Referring to FIG. 3 there is shown a memory subsystem 10 of the present invention.

The memory subsystem 10 is connectable to a host device 8. The subsystem 10 comprises a memory controller 14, a NAND flash memory 12, and a Real Time Clock 16. As shown in FIG. 4, the memory controller 14 comprises a processor 20 and a non-volatile memory 22, which can be in the nature of a NOR memory for storing program instruction codes for execution by the processor 20. The processor 20 executes the code stored in the memory 22 to operate the subsystem 10 in the manner described hereinafter. The controller 14 is connected to the NAND memory device 12 by an address bus 28 and a data bus 30. The buses 28 and 30 may be parallel or serial. In addition, they may also be multiplexed. Thus, the controller 14 controls the read and program (or write) and erase of the NAND flash memory device 12. As is well known, the NAND flash memory device 12 has a plurality of blocks with each block having a plurality of memory cells that are erased together at the same time.

The controller 14 is also connected to the host 8 by a plurality of buses: address bus 32, data bus 34 and control bus 36. Again these buses 32, 34, and 36 may be parallel or serial. In addition, they may also be multiplexed. The subsystem 10 also comprises a Real Time Clock (RTC) 16. The RTC 16 can supply clock signals to the controller 14. The communication between the controller 14 and the RTC 16 is via a Serial Data Address (SDA) bus. Of course, any other form of communication with any other type of bus between the controller 14 and the RTC 16 is within the scope of the present invention. The controller 14 can read the real time clock signals from the RTC 16 via the SDA. In addition the controller 14 can set the alarm time via the SDA signal from the controller 14 to the RTC 16. Further, the RTC 16 has an elapsed timer/counter. Thus, the controller 14 can set the elapsed timer/counter through the SDA. When the timer times out, the RTC 16 will generate an interrupt signal supplied to the controller 14 on the INT# pin. In addition, the RTC 16 can generate an interrupt signal for the host 8. This is particularly useful, since the RTC 16 can be battery powered. When all of the host 8 is powered down or off to save power consumption (except for power management control software), upon the generation of the interrupt signal by the RTC 16, the interrupt signal will cause the host 8 with its power management control software to apply power to the subsystem 10 to commence operations. Such operation, as will be seen, can include retention scan/refresh operations.

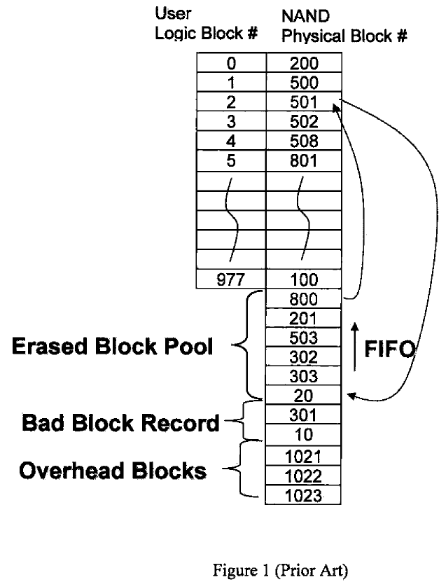

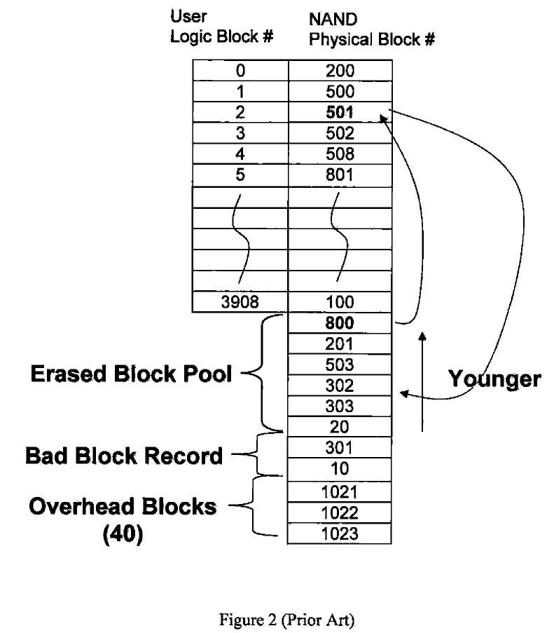

In the present invention, the controller 14 through the processor 20 executes the program code stored in the memory 22 to cause the NAND memory 12 to be partitioned into a plurality of partitions, with each partition having adjustable parameters for wear level and data retention different from the other partitions. Specifically, for the operation of wear level, the controller 14 can control the aforementioned prior art method, as described in FIGS. 1 and 2, by having different parameters. For example, the physical block 501 might be returned to the Erased Block Pool, immediately upon an update to its contents, or it might be reused, a plurality of times before being returned to the Erased Block Pool. Thus, with the dynamic wear leveling method of the prior art, different partitions may have different parameters associate therewith when data in a block is updated. Alternatively, the following wear level method may also be used with different parameters for different partitions of the NAND memory 12.

### Wear Level

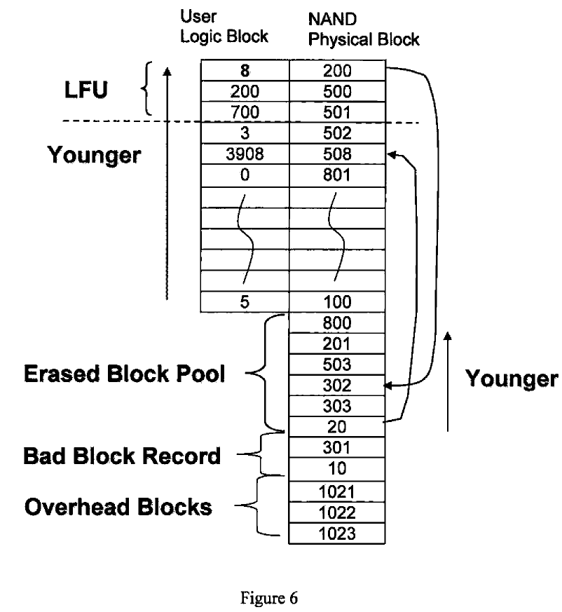

Referring to FIG. 6 there is shown a schematic diagram of the method of the present invention. Similar to the method shown and described above for the embodiment shown in FIGS. 1 and 2, the NAND memory device 12 is characterized by having a plurality of blocks, with each block comprising a plurality of bits or memory cells, which are erased together. Thus, in an erase operation the memory cells of an entire block are erased together.

Further, associated with each block is a physical address, which is mapped to a user logical address, by a table, called a Mapping Table, which is well known in the art. The memory device 12 has a first plurality of blocks that are used to store data (designated as user logical blocks, such as 8, 200, 700, 3, 3908 and 0, each with its associated physical blocks address designated as 200, 500, 501, 502, 508, 801 etc.). The memory device 12 also comprises a second plurality of blocks that comprise spare blocks, bad blocks and overhead blocks. The spare blocks may be erased blocks and form the Erased Pool and other blocks that do not store data, or store data that has not been erased, or store status/information data that may be used by the controller 14. Further, each of the physical blocks in the Erased Pool has a counter counting the number of times that block has been erased. Thus, as the physical block 200 is erased, its ATTORNEY DOCKET 351913-993970 associated erase counter is incremented. The blocks in the Erased Pool are candidates for swapping. The erase operation can occur before a block is placed into the Erased Pool or immediately before it is used and moved out of the Erased Pool. In the latter event, the blocks in the Erased Pool may not all be erased blocks.

When a certain block, such as user block 8, having a physical address of 200 (hereinafter all blocks shall be referred to by their physical address) is updated, some of the data from that block along with new data may need to be written to a block from the Erased Pool. Thereafter, block 200 must be erased and is then “moved” to be associated with the Erased Pool (if the erased block can still retain data. Otherwise, the erased block is “moved” to the blocks that are deemed “Bad Blocks”).

The “movement” of the physical block 200 from the first plurality of blocks (the stored data blocks) to the second plurality of blocks (the Erased Pool or the Bad Blocks) occurs by simply updating the Mapping Table. Schematically, this is shown as the physical address block 200 is “moved” to the Erased Pool.

In the present invention, however, the wear-level method may be applied even if there is no update to any data in any of the blocks from the first plurality of blocks. This is called static wear leveling. Specifically, within the first plurality of blocks, a determination is first made as to the Least Frequently Used (LFU) blocks, i.e. those blocks having the lowest erase count stored in the erase counter. The LFU log may contain a limited number of blocks, such as 16 blocks, in the preferred embodiment. Thus, as shown in FIG. 6, the LFU comprises physical blocks 200, 500 and 501, with block 200 having the lowest count in the erase counter.

Thereafter, the block with the lowest count in the erase counter within the LFU, such as physical block 200, is erased (even if there is no data to be updated to the physical block 200). The erased physical block 200 is then “moved” to the second plurality of blocks, i.e. either the Erased Pool or the Bad Blocks. Alternatively, the block may be transferred to the second plurality of blocks before being erased.

The plurality of erased blocks in the Erased Pool is also arranged in an order ranging from the “youngest”, i.e. the block with the count in the erase counter being the lowest, to the “oldest”, i.e. the block with the count in the erase counter being the highest. The block which is erased from the first plurality and whose erase counter is incremented has its count in the erase counter compared to the erase counter of all the other blocks in the Erased Pool and arranged accordingly. The arrangement need not be in a physical order. The arrangement, e.g. can be done by a link list or a table list or any other means.

The block with the highest erase count, or the “oldest” block (such as physical block 20) from the erased Pool is then used to store data retrieved from the “youngest” block (physical block 200) from the LFU in the first plurality of blocks. Physical block 20 is then returned to the first plurality of blocks.

Based upon the foregoing description, it can been that with the static wear level method of the present invention, blocks in the first plurality which are not updated or are infrequently updated, will be “recycled” into the Erased Pool and re-used, thereby causing the wear to be leveled among all of the blocks in the NAND memory 12. It should be noted that in the method of the present invention, when the “youngest” block among the LFU is returned to the Erased Pool, the “oldest” block from the Erased Pool is used to replace the “youngest” block from the LFU. This may seem contradictory in that the “youngest” from LFU may then reside in the Erased Pool without ever being subsequently re-used. However, this is only with regard to the static wear level method of the present invention. It is contemplated that as additional data is to be stored in the NAND memory 12 and a new erased block is requested, that the “youngest” erased block from the Erased Pool is then used to store the new or additional data. Further, the “youngest” block from the Erased Pool is also used in the dynamic wear level method of the prior art. Thus, the blocks from the Erased Pool will all be eventually used. Furthermore, because the static wear level method of the present invention operates when data to a block is not being replaced, there are additional considerations, such as frequency of operation (so as not to cause undue wear) as well as resource allocation. These parameters, such as frequency of operation may be different for different partitions of the memory device 12. These issues are discussed hereinafter.

At the outset, the issue is when are the blocks within the first plurality of blocks scanned to create the LFU, which is used in the subsequent static wear level method of the present invention. There are a number of ways this can be done. What follows are various possible techniques, that are illustrative and not meant to be exhaustive. Further, some of these methods may be collectively used together. Again, all of these parameters may differ for different partitions of the memory device 12.

First, the controller 14 can scan the first plurality of blocks when the NAND memory 12 is first powered up.

Second, the controller 14 can scan the first plurality of blocks when the host 8 issues a specific command to scan the first plurality of blocks in the NAND memory 12. As a corollary to this method, the controller 14 can scan the first plurality of blocks when the host 8 issues a READ or WRITE command to read or write certain blocks in the NAND memory 12. Thereafter, the controller 14 can continue to read all of the rest of the erase counters within the first plurality of blocks. In addition, the controller 14 may limit the amount of time to a pre-defined period by which scanning would occur after a READ or WRITE command is received from the host 8.

Third, the controller 14 can scan the first plurality of blocks in the background. This can be initiated, for example, when there has not been any pending host command for a certain period of time, such as 5 m sec, and can be stopped when the host initiates a command to which the controller 14 must respond.

Fourth, the controller 14 can initiate a scan after a predetermined event, such as after a number of ATA commands is received by the controller 14 from the host 8.

Once it is determined when the erase counters for each of the blocks in the first plurality of blocks is scanned to create the LFU, the next determining element is the methodology by which the erase counters of the first plurality of blocks are scanned. Again, there are a number of methods, and what is described hereinbelow is illustrative only and is by no means exhaustive.

First, the controller 14 can scan all of the blocks in the first plurality of blocks in a linear manner starting from the first entry in the Mapping Table, until the last entry.

Second, the controller 14 can scan the blocks in the first plurality of blocks based upon a command from the host 8. For example, if the host 8 knows where data, such as operating system programs, are stored and thus which blocks are more probable of containing the “youngest” blocks, then the host 8 can initiate the scan at certain logical address or to indicate the addresses where scanning should be limited.

Third, the controller 14 can also scan all the blocks of the first plurality of blocks in a random manner. The processor in the controller 14 can include a random number generator which generates random numbers that can be used to correlate to the physical addresses of the blocks.

Fourth, the controller 14 can also scan all the blocks of the first plurality of blocks in a pseudo random manner. The processor in the controller 14 can include a pseudo random number generator (such as a prime number generator) which generates pseudo random numbers that can be used to correlate to the physical addresses of the blocks.

Once the LFU is created, then the method of the present invention can be practiced. However, since the static wear level method of the present invention does not depend on the updating of data in a block, the issue becomes when does the exchange of data between the “youngest” block in the LFU and that of the “oldest” block in the Erased Pool occur. There are a number of ways this can be done. These parameters may also differ for the different partitions of the memory device 12. Again, what follows are various possible techniques, and is illustrative and not meant to be exhaustive.

First, the controller 14 can exchange a limited number of blocks, such as sixteen (16), when the NAND memory 12 is first powered up.

Second, the controller 14 can exchange a number of blocks in response to the host 8 issuing a specific command to exchange the number of blocks. As a corollary to this method, the controller 14 can also exchange a limited number of blocks, such as one (1), after the host 8 issues a READ or WRITE command to read or write certain blocks in the NAND memory 12. Thereafter, the controller 14 can exchange one block.

Third, the controller 14 can exchange a limited number of blocks, such as sixteen (16), in the background. This can be initiated, for example, when there has not been any pending host command for a certain period of time, such as 5 m sec, and can be stopped when the host initiates a command to which the controller 14 must respond.

Fourth, the controller 14 can exchange a limited number of blocks, such as one (1) after a predetermined event, such as after a number of ATA commands is received by the controller 14 from the host 8.

It should be clear that although the method of the present invention levels the wear among all of the blocks in the NAND memory 12, the continued exchange of data from one block in the LFU to another block in the Erased Pool can cause excessive wear. There are a number of methods to prevent unnecessary exchanges. Again, these parameters may also differ for each partition of the memory device 12. What follows are various possible techniques, and is illustrative and not meant to be exhaustive. Further, the methods described herein may be collectively implemented.

First, a determination can be made between the count in the erase counter of the “youngest” in the LFU and the “oldest” in the blocks of the Erased Pool. If the difference is within a certain range, the exchange between the “youngest” in the LFU and the “oldest” block in the Erased Pool would not occur. The difference between the count in the erase counter of the “youngest” in the LFU and the “oldest” block in the Erased Pool can also be stored in a separate counter.

Second, the controller 14 can maintain two counters: one for storing the number of host initiated erase counts, and another for storing the number of erase counts due to static wear level method of the present invention. In the event, the difference between the two values in the two counters is less than a pre-defined number, then the static wear level method of the present invention would not occur. The number of host initiated erase counts would include all of the erase counts cause by dynamic wear level, i.e. when data in any block is updated, and any other events, that causes an erase operation to occur.

Third, the controller 14 can set a flag associated with each block. As each block is exchanged from the Erased Pool, the flag is set. Once the flag is set, that block is no longer eligible for the wear level method of the present invention until the flags of all the blocks within the first plurality of blocks are set. Thereafter, all of the flags of the blocks are re-set and the blocks are then eligible again for the wear level method of the present invention.

Fourth, a counter is provided with each block in the first plurality of blocks for storing data representing the time when that block was last erased, pursuant to the method of the present invention. In addition, the controller 14 provides a counter for storing the global time for the first plurality of blocks. In the event, a block is selected to have its data to be exchanged with a block from the Erased Pool, the counter storing the time representing when the last erase operation occurred is compared to the global time. In the event the difference is less than a predetermined number, (indicating that the block of interest was recently erased pursuant to the static wear level method of the present invention), then the block is not erased and is not added to the LFU (or if already on the LFU, it is removed therefrom).

As is well known in the art, flash memory, and especially NAND memory 12 is prone to error. Thus, the controller 14 contains error detection and error correction software. Another benefit of the method of the present invention is that, as each block in the LFU is read and then the data is recorded to an erased block from the Erased Pool, the controller 14 can determine to what degree the data from the read block contains errors. If the data read from the read block is data which does not need correction, then the erased block is returned to the Erased Pool. However, if data read from the read block contains correctable error, (and depending upon the degree of correction), the read block may then be returned to the Bad Block pool. In this manner, marginally good blocks can be detected and retired before the data stored therein becomes unreadable.

Thus, as can be seen from the foregoing, various parameters may be adjusted for different partitions of NAND memory 12. The controller 14 also operates to perform the function of data retention with different parameters for each partition. Specifically one method of achieving data retention is as follows:

### Data Retention

In the method of the present invention, upon power up, the controller 14 retrieves the computer program code stored in the NOR non-volatile memory 22. The controller 14 then reads the time stamp signal from the RTC 16. The time stamp signal from RTC 22 indicates the “current” time. The controller 14 compares the “current” time as set forth in the time stamp signal with a time signal stored in the NOR non-volatile memory 22 to determine if sufficient time has passed since the last time, controller 14 has performed the data retention operation on the NAND memory 12. The amount of time that is deemed “sufficient” can be varied for each partition. If sufficient time has passed since the last time the controller 14 has performed the data retention operations on the NAND memory 12, then the controller 14 initiates the method to check for data retention.

In that event, the controller 14 performs a data retention and refresh operation on the NAND memory 12 by reading data from each of the memory cells from one of the blocks in the NAND memory 12. Because the controller 14 has error correction coding, if the data read contains errors, then such data is corrected by the controller 14. The corrected data, if any, is then written back into the NAND memory device 12 in a block different from the block from which the data was read. In the event the data read is correct and does not require error correction, then the data is left stored in the current block. The controller 14 then proceeds to read the data for all the rest of the blocks of the NAND memory 12. Alternatively, if the data read is corrected indicating an error, then the block from which it is read is erased, and the corrected data is written into the erased block. After the corrected data is written, the retention time is reset. The writing of corrected data to the same block from which it was read can be used if the retention error is a soft failure. In that event, the block is not damaged and may be re-used.

Alternatively, the controller 14 can compare the data read from each of the memory cells of a block with a margin signal. In the event the signal read from a memory cell is greater or less than the margin signal, for all the memory cells in a block, then the data is left stored in the block from which it was read. However, in the event the signal from one of the memory cells of a block is greater or less than the margin signal, then all of the signals from the memory cells of a block are written into a block different from the block from which the signals from the memory cells were read. Again, if the error is a soft failure, then the corrected data may be written into an erased block from which the data was read.

Although the foregoing describes RTC 16 issuing a time stamp signal to the controller 14, the method of data retention operation can also be accomplished as follows. During normal operation, the host device 8 can issue a command to the controller 14 to initiate data retention check operation. Alternatively, each block of memory cells in the NAND device 12 may have a register associated therewith. During “normal” read operation, if the read operation shows the data either needs to be corrected or the signal from the memory cells read is outside of the margin compared to a margin signal, then the register associated with that block is set. Once register has been set, the blocks of the NAND device 12 may then be read and written to the same or other locations.

Other possibilities to initiate the data retention method is to initiate the data retention operation upon either power up of power down of the controller 14, i.e. without waiting for a time stamp signal from the RTC 16. Other possible initiation methods include the controller 14 having a hibernation circuit that periodically performs a data retention operation, wherein the data retention operation comprises reading data from blocks and either determining if the data is correct or is within a margin, and do nothing, or writing the data to the same or different blocks.

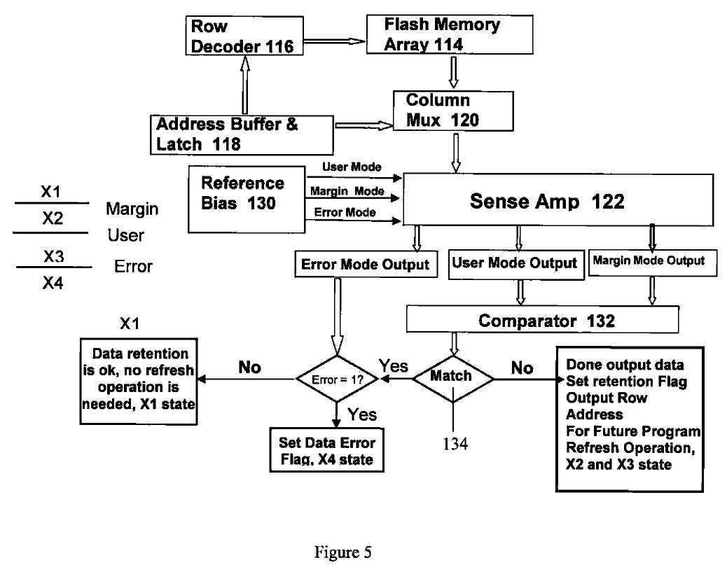

Referring to FIG. 5 there is shown a block level diagram of a NAND type memory 12 for use in the system 10 of the present invention. As is well known, the NAND memory 12 comprises an array 114 of NAND memory cells arranged in a plurality of rows and columns. An address buffer latch 118 receives address signals for addressing the array 114. A row decoder 116 decodes the address signals received in the address latch 118 and selects the appropriate row(s) of memory cells in the array 114. The selected memory cell(s) is (are) multiplexed through a column multiplexer 120 and are sensed by a sense amplifier 122. A reference bias circuit 130 generates three different sensing level signals (or margin signals), represented by four margin signals: X1, X2, X3, and X4 which are supplied to the sense amplifier 122 during the read operation.

The margin signal X1 provides the minimum margin signal required for data to retain at the minimum amount of charge on its floating gate. This will ensure enough charge retention for a certain period of time with requiring a refresh operation. The margin signal X2 is a user mode margin signal which is the normal margin read signal. The margin signal X3 is a margin signal signifying an error mode and provides a flag which requires refresh operation if data stays at this level. Finally, the margin signal X4 is a margin signal which signifies that the data requires ECC (Error Correction Checking) protocol to correct it.

From the sense amplifier 122, there are three possible outputs: Margin Mode, User Mode, and Error Mode. If the signal is a Margin Mode output or a User Mode output, the signal is supplied to a comparator 132. From the comparator 132, the signal is supplied to a Match circuit 134. If the Match circuit 134 indicates a no match, then a flag for the particular row of memory cell that was addressed is set to indicate that a refresh operation needs to be performed. If the Match circuit 134 indicates a match, then the controller 14 makes a determination if an error bit is set. If not, then the data retention is within normal range and no refresh operation needs to be done. The Error Mode output of the sense amplifier 122 sets an error bit, even if the data is corrected by ECC. If the Error Bit is set, then the data is written to another portion of the Array 114 and a data refresh operation needs to be done.

From the foregoing, it can be seen that by partitioning the NAND memory 12 into a plurality of partitions each with different parameters for wear level and data retention, the storing of data (or code) within the NAND memory 12 with respect to data retention and endurance can be optimized for the particular partition for the type of data (or code) stored therein.

What is claimed is:

1. A non-volatile memory subsystem comprising:
a non-volatile memory device;
a memory controller for controlling the operation of said non-volatile memory device;
said memory controller having a processor for executing computer program instructions for partitioning said memory device into a plurality of partitions, with each partition having adjustable parameters for wear level and data retention; and
a clock for supplying timing signals to said memory controller.

2. The memory subsystem of claim 1 wherein said non-volatile memory device is a NAND memory.

3. The memory subsystem of claim 1 wherein said non-volatile memory device has a data storage section and an erased storage section, wherein the data storage section has a first plurality of blocks and the erased storage section has a second plurality of blocks, and wherein each of the first and second plurality of blocks has a plurality of non-volatile memory bits that are erased together, and each block has an associated counter for storing a count of the number of times the block has been erased, wherein the memory controller having program instructions for controlling wear level are configured to determine from the count in the counters associated with the blocks of the first plurality of blocks to select a third block;
determine from the count in the counters associated with the blocks of the second plurality of blocks to select a fourth block;
transfer data from the third block to the fourth block, and associating said fourth block with said first plurality of blocks; and
erase said third block and incrementing the count in the counter associated with said third block, and associating said third block with said second plurality of blocks.

4. The memory subsystem of claim 3 wherein said program instructions are configured to select the third block based upon the count being the smallest among the counters associated with the first plurality of blocks, and wherein said program instructions are configured to select the fourth block based upon the count being the largest among the counters associated with the second plurality of blocks.

5. The memory subsystem of claim 4 wherein said program instructions are configured to perform the steps of transfer and erase if the difference between the largest and the smallest count in the counters is greater than a pre-set amount.

6. The memory subsystem of claim 4 wherein the program instructions are configured to determine from the count in the counters associated with the blocks of the first plurality of blocks to select a third block;
determine from the count in the counters associated with the blocks of the second plurality of blocks to select a fourth block;
transfer data from the third block to the fourth block, and associating said fourth block with said first plurality of blocks; and
erase said third block and incrementing the counter associated with said third block, and associating said third block with said second plurality of blocks,
in response to a first command supplied from a source external to the non-volatile memory device.

7. The memory subsystem of claim 6 wherein said memory controller further comprising a command counter, wherein said command counter is incremented when the first command is received.

8. The memory subsystem of claim 7 wherein the program instructions are configured to
determine from the count in the counters associated with the blocks of the first plurality of blocks to select a third block;
determine from the count in the counters associated with the blocks of the second plurality of blocks to select a fourth block;
transfer data from the third block to the fourth block, and associating said fourth block with said first plurality of blocks; and
erase said third block and incrementing the counter associated with said third block, and associating said third block with said second plurality of blocks,
in response to a second command generated internally to the memory controller.

9. The memory subsystem of claim 8 further comprising an internal command counter, wherein said internal command counter is incremented when the second command is generated.

10. The memory subsystem of claim 9 wherein the program instructions are configured to determine from the count in the counters associated with the blocks of the first plurality of blocks to select a third block;
determine from the count in the counters associated with the blocks of the second plurality of blocks to select a fourth block;
transfer data from the third block to the fourth block, and associating said fourth block with said first plurality of blocks; and
erase said third block and incrementing the counter associated with said third block, and associating said third block with said second plurality of blocks,
in the event the difference between the count in the command counter and the count in the internal command counter is greater than a pre-set number.

11. The memory subsystem of claim 1, wherein said memory controller for interfacing with said clock for receiving a time-stamp signal, said program instructions for controlling data retention are configured to:
receiving by the memory controller the time stamp signal;
comparing the received time stamp signal with a stored signal wherein the stored signal is a time stamp signal received earlier in time by the memory controller; and
determining when to perform a data retention and refresh operation for data stored in the memory array based upon the comparing step.

12. The memory subsystem of claim 11 wherein said non-volatile memory device has a plurality of blocks with each block having a plurality of memory cells that are erased together, wherein said program instructions are further configured to:
a) reading data from each of the memory cells from one of said blocks;
b) correcting said data read, if need be, to form corrected data, by the memory controller;
c) writing corrected data, if exists, to a different block of said array; and
d) repeating the steps (a)-(c) for different blocks of the array until all of the blocks have been read.

13. The memory subsystem of clam 11 wherein said non-volatile memory device has a plurality of blocks with each block having a plurality of memory cells that are erased together, wherein said program instructions are further configured to:
a) reading the data signal from each of the memory cells from one of said blocks;
b) comparing the data signal read to a margin signal;
c) writing the data corresponding to the data signal into a different memory cell of a different block of said array, in the event the result of the comparing step (b) indicates the necessity of writing the data corresponding to the data signal to a different memory cell; and
d) repeating the steps (a)-(c) for different blocks of the array until all of the blocks have been read.

14. A memory controller for controlling the operation of a non-volatile memory device, said memory controller comprising:
a processor;
a memory for storing computer program instructions for execution by said processor, said program instructions configured to partition the non-volatile memory device into a plurality of partitions, with each partition having adjustable parameters for wear level and data retention.

15. The memory controller of claim 14 wherein said non-volatile memory device has a data storage section and an erased storage section, wherein the data storage section has a first plurality of blocks and the erased storage section has a second plurality of blocks, and wherein each of the first and second plurality of blocks has a plurality of non-volatile memory bits that are erased together, and each block has an associated counter for storing a count of the number of times the block has been erased, wherein the program instructions stored in the memory for controlling wear level are configured to
determine from the count in the counters associated with the blocks of the first plurality of blocks to select a third block;
determine from the count in the counters associated with the blocks of the second plurality of blocks to select a fourth block;
transfer data from the third block to the fourth block, and associating said fourth block with said first plurality of blocks; and
erase said third block and incrementing the count in the counter associated with said third block, and associating said third block with said second plurality of blocks.

16. The memory controller of claim 15 wherein said program instructions are configured to select the third block based upon the count being the smallest among the counters associated with the first plurality of blocks, and wherein said program instructions are configured to select the fourth block based upon the count being the largest among the counters associated with the second plurality of blocks.

17. The memory controller of claim 16 wherein said program instructions are configured to perform the steps of transfer and erase if the difference between the largest and the smallest count in the counters is greater than a pre-set amount.

18. The memory controller of claim 16 wherein the program instructions are configured to
determine from the count in the counters associated with the blocks of the first plurality of blocks to select a third block;
determine from the count in the counters associated with the blocks of the second plurality of blocks to select a fourth block;
transfer data from the third block to the fourth block, and associating said fourth block with said first plurality of blocks; and
erase said third block and incrementing the counter associated with said third block, and associating said third block with said second plurality of blocks,
in response to a first command supplied from a source external to the non-volatile memory device.

19. The memory controller of claim 18 wherein said memory controller further comprising a command counter, wherein said command counter is incremented when the first command is received.

20. The memory controller of claim 19 wherein the program instructions are configured to determine from the count in the counters associated with the blocks of the first plurality of blocks to select a third block;
determine from the count in the counters associated with the blocks of the second plurality of blocks to select a fourth block;
transfer data from the third block to the fourth block, and associating said fourth block with said first plurality of blocks; and
erase said third block and incrementing the counter associated with said third block, and associating said third block with said second plurality of blocks,
in response to a second command generated internally to the memory controller.

21. The memory controller of claim 20 further comprising an internal command counter, wherein said internal command counter is incremented when the second command is generated.

22. The memory controller of claim 21 wherein the program instructions are configured to
determine from the count in the counters associated with the blocks of the first plurality of blocks to select a third block;
determine from the count in the counters associated with the blocks of the second plurality of blocks to select a fourth block;
transfer data from the third block to the fourth block, and associating said fourth block with said first plurality of blocks; and
erase said third block and incrementing the counter associated with said third block, and associating said third block with said second plurality of blocks,
in the event the difference between the count in the command counter and the count in the internal command counter is greater than a pre-set number.

23. The memory controller of claim 14, wherein said memory controller for interfacing with said clock for receiving a time-stamp signal, said program instructions for controlling data retention are configured to:
receiving by the memory controller the time stamp signal;
comparing the received time stamp signal with a stored signal wherein the stored signal is a time stamp signal received earlier in time by the memory controller; and
determining when to perform a data retention and refresh operation for data stored in the memory array based upon the comparing step.

24. The memory controller of claim 14 wherein said non-volatile memory device has a plurality of blocks with each block having a plurality of memory cells that are erased together, wherein said program instructions are further configured to:
a) reading data from each of the memory cells from one of said blocks;
b) correcting said data read, if need be, to form corrected data, by the memory controller;
c) writing corrected data, if exists, to a different block of said array; and
d) repeating the steps (a)-(c) for different blocks of the array until all of the blocks have been read.

25. The memory controller of claim 14 wherein said non-volatile memory device has a plurality of blocks with each block having a plurality of memory cells that are erased together, wherein said program instructions are further configured to:
a) reading the data signal from each of the memory cells from one of said blocks;
b) comparing the data signal read to a margin signal;
c) writing the data corresponding to the data signal into a different memory cell of a different block of said array, in the event the result of the comparing step (b) indicates the necessity of writing the data corresponding to the data signal to a different memory cell; and
d) repeating the steps (a)-(c) for different blocks of the array until all of the blocks have been read.
